(19) United States
(12) Patent Application Publication
(10) Pub. No.: US 2004/0240209 A1
(43) Pub. Date: Dec. 2, 2004

(54) LED navigation lights

(76) Inventors: Paul Raymond Snow JR., Port Aransas, TX (US); Joseph K. Filippone, Houston, TX (US)

Correspondence Address: Paul R. Snow, Jr., PO Box 3015, Port Aransas, TX, 78373, US

(21) Appl. No.: 10/453,332

(22) Filed: Jun. 2, 2003

(51) Int. Cl. F21V 3/00

(52) U.S. Cl. 362/311

(57) ABSTRACT

Navigations lights (especially for marine navigation) are plagued by corrosion in the incandescent light bulb sockets and short bulb life. Navigation lights illuminated by LEDs are long-lived, low in power consumption, and much more durable in the proper casing.

These lights will be attached in, an array of appropriate color, to a PC board and cast in a medium along with an appropriate limiting resistor if needed. This casting will form a detachable light module where only the tips of the LEDs and the wire power leads protrude from the module. Thus, the module will be reasonably protected from water intrusion and shock. Also, there will be no moving parts or sockets to corrode as in an incandescent light fixture.

This light module will be placed in a hollow in a protective housing. This hollow will form the appropriate arc of visibility required for each light.

### EMBODIMENT

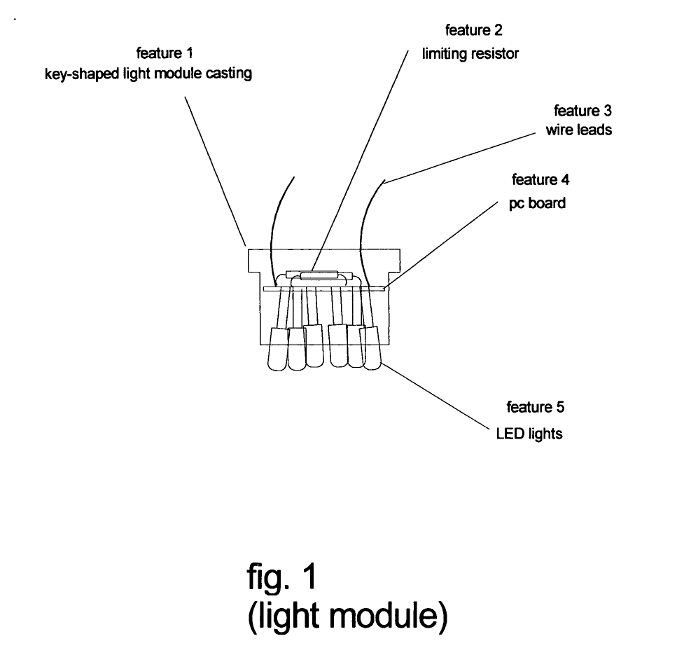

FIG. 1

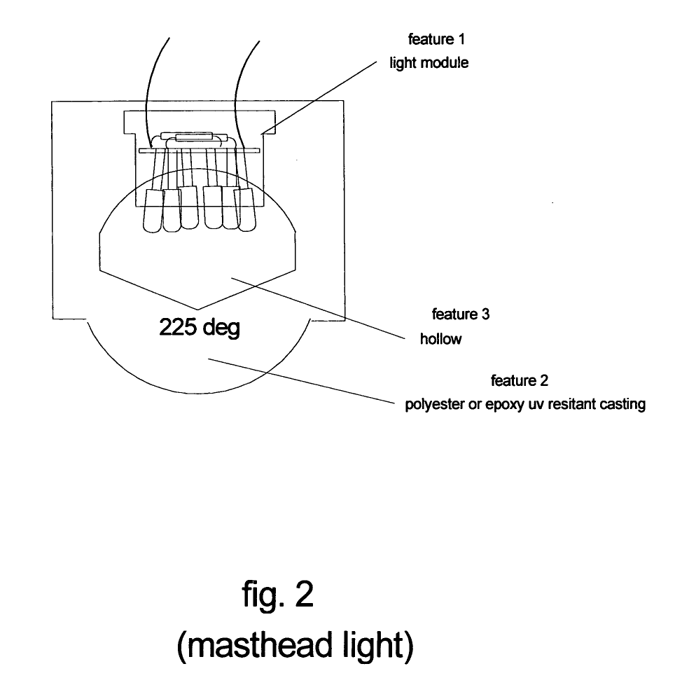

FIG. 1 shows a preferred embodiment of the invention, which is an LED light module. A group of LEDs (5) is positioned in a molded clear casing (1) which fits into the hollow between the LED light module and the interior surface of the molded clear casing (FIGS. 2,3,4,5,6 Feature 2). The molded clear casing (1) is preferably a polyester resin, but can also be made of a clear epoxy casting. The LEDs (1) are preferably two to three circuits of 3 6,000 mcd-8,000 colored LEDs. These colors will be red, white and green depending on the application for which they are being used. The LEDs in FIG. 1 will be arranged in a staggered (5) 2-row pattern to save space. The staggered pattern (5) will be soldered to the P.C Board (5) along with the limiting resistor (2). The LED will range from 2.2 volts to 3.5 volts depending on which marine navigation light is being used. The wire leads (3) will be made of tinned marine wire to be soldered onto the P.C board (4). The only parts of the light module exposed to the environment are the wires (3), which are designed for marine use. The rest of the module is completely encapsulated in the resin.

### Mastehead Light

FIG. 2

The masthead light is to cast a visible light over a 225 degree arc ahead. This hollow is achieved by casting light (FIG. 1) across a hollow (3) onto the rear surface of an angled lens (3). This lens design magnifies the apparent light from the LED module (FIG. 1) and allows it to be seen throughout the intended field of view. The outer casting (2) is molded from one piece of polyester or epoxy resin and has a hollow key slot to accept the light module (FIG. 1).

### Anchor Light

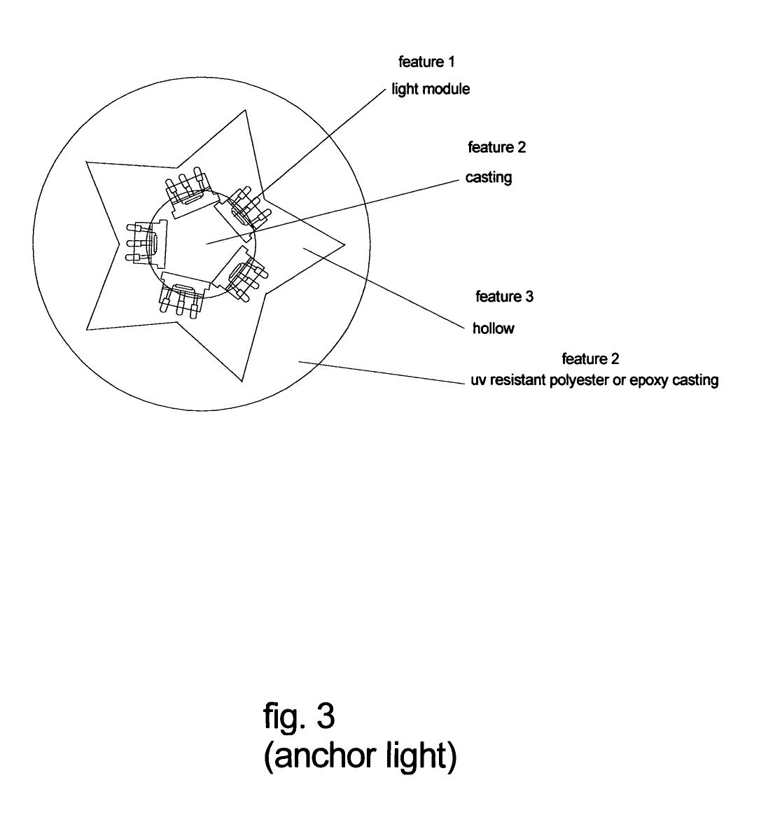

FIG. 3

The anchor light is to cast light to be visible over 360 degrees. The outer casting is molded from one piece of polyester or epoxy resin (2) and has a hollow key slot to accept the light module (FIG. 1). The 260 degree field of view is achieved by casting light (FIG. 1) across a hollow (3) in the casting onto the rear surface of an angled lens shown in (FIG. 3, 3).

### Starboard Running Light

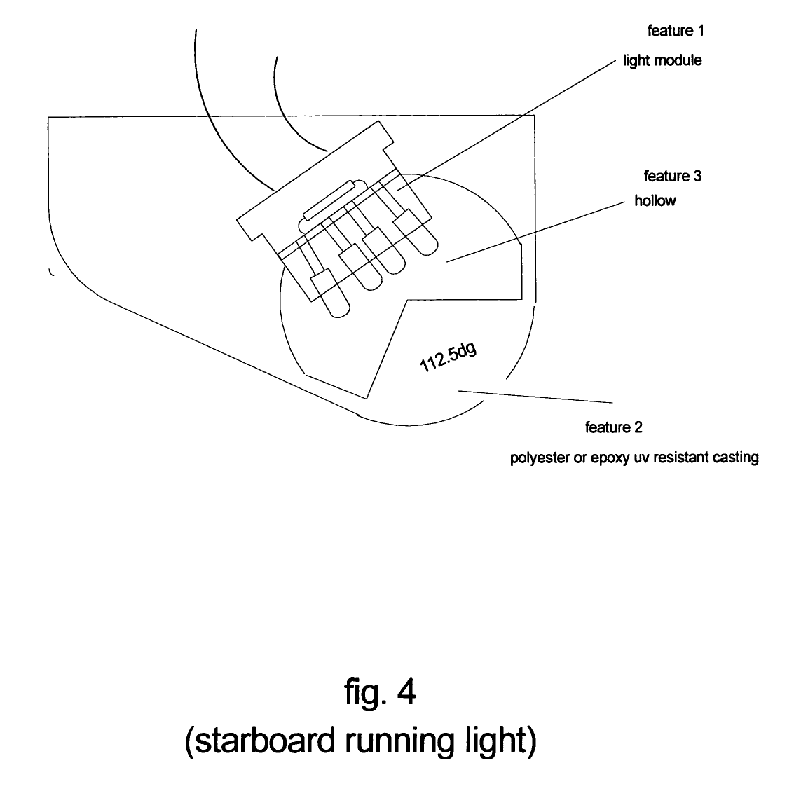

FIG. 4

The starboard running light is to cast a green light to be visible over 112.5 degrees from ahead to beam. The outer casting is molded from one-piece polyester or epoxy resin (2) and has a hollow in the casting (3) where the LED module (FIG. 1) will cast light across this hollow onto the rear surface of an angled lens in the hollow (3). This lens magnifies the apparent light from the LED module (FIG. 1) and allows it to be seen throughout the 112.5 degree intended field of view.

### Port Running Light

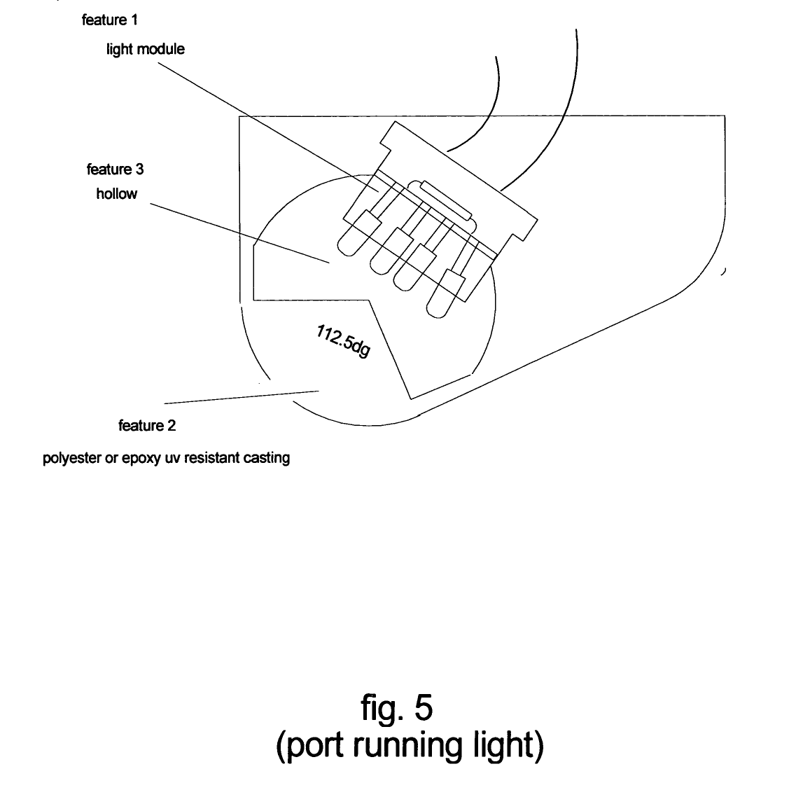

FIG. 5

To cast red light to be visible over 112.5 degrees from ahead to beam. The outer casting is molded from one piece of polyester or epoxy resin (2) and has a hollow in the casting (3) where the LED module (FIG. 1) will cast light across this hollow onto the rear surface of the angled lens, which is part of the casting (3). This lens magnifies the apparent light from the LED module (FIG. 1) and allows it to be seen throughout the 112.5 degree intended field of view.

### Stern Light

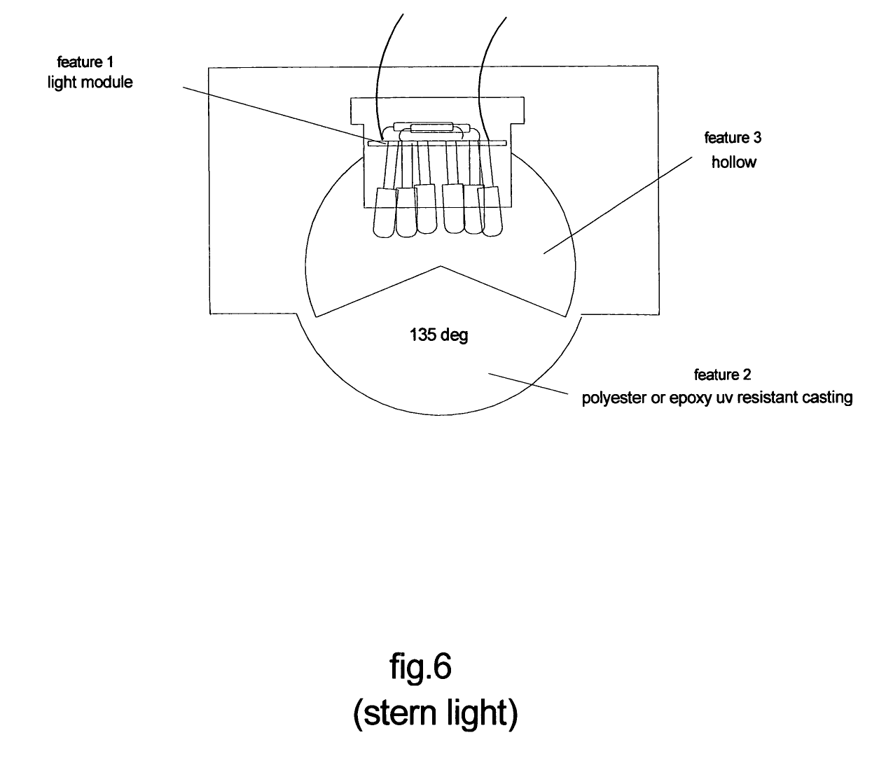

FIG. 6

The stern light is to be visible over 135 degrees from astern. The outer casting (2) is molded from one piece of polyester or epoxy resin and has a hollow key slot to accept the light module (FIG. 1). The 135 degree field of view is achieved by casting light (FIG. 1) across the hollow (3) in the casting onto the rear surface of an angled lens shown in (3). This lens design magnifies the apparent light from the LED light module (FIG. 1) and allows it to be seen throughout the 135 degree field of view.

1. An illumination device comprised of at least one LED surrounded by a casting that allows passage of light wherein a hollow is formed between an illuminating portion of the LED and an interior surface of the casting.

2. The illumination device of claim 1 wherein the casting is comprised of UV-resistant resin, polyester resin, or epoxy resin.

3. The illumination device of claim 1 wherein the casting is clear.

4. The illumination device of claim 1 wherein the casting is tinted.

5. The illumination device of claim 1 wherein the LED emits red, green, or white light.

6. The illumination device of claim 1 wherein the LED is fitted into a mount, which connects to a power source.

7. The illumination device of claim 6 wherein the mount forms a friction fit with the casting.

8. The illumination device of claim 6 wherein the mount is adapted to provide threaded attachment to the casting

9. The illumination device of claim 6 wherein the mount is adapted to provide epoxy attachment to the casting.

10. The illumination device of claim 6 wherein the mount is adapted to provide a mechanical attachment to the casting.

11. The illumination device of claim 1 wherein the casting substantially prevents water from contacting the LED.

12. The illumination device of claim 1 wherein the casting is shaped to permit passage of light over an arc measuring 225 degrees for the masthead light, 135 degrees for stern light, 112.5 for port and starboard running lights and anchor light which arcs light into a total 360 degrees.

13. The illumination device of claim 1 wherein a material that blocks passage of light encompasses a portion of the casting and leaves open a portion of the casting to create the desired arc.

14. The illumination device of claim 13 wherein an arc of 135 degrees is created for stern light.

15. The illumination device of claim 13 wherein an arc of 112.5 degrees is created for both port and starboard running lights.

16. The illumination device of claim 13 wherein an arc measuring 360 degrees in created for the anchor light.

17. The illumination device of claim 1 allows light to be cast on angled lens, which magnifies apparent light emitted.

18. A process for making an illumination device comprised of fitting at least one LED into a casing that allows passage of light, wherein a hollow is formed between an illuminating portion of the LED and an interior surface of the casting.

19. The process as claimed in claim 18 wherein the casting is cast in a mold.

20. Illumination device as claimed in claim 18 wherein a material that blocks passage of light encompasses a portion of the casting and leaves open a portion of the casting to create the desired arc.

21. Illumination device of claim 18 wherein the hollow allows light from LEDs to be cast on an angled lens, which magnifies apparent light, emitted.

22. The process as claimed in claim 18 wherein the casing is cast in a mold.

23. The process as claimed in claim 18 wherein one or more LEDs mounted on a PC board and cast in a mold to form a light module.

24. The process as claimed in claim 18 wherein a slot for the module and hollow with an angle are formed when cast in a mold.

25. The process as claimed in claim 18 wherein a slot for the module and hollow with an angle is cut from a block of material.

26. The process as claimed in claim 18 wherein the entire casting is placed in a plastic cover for protection and attachment to vehicle.

27. The process as claimed in claim 18 wherein the entire casting is placed in a metal cover for protection and attachment to the vehicle.
